(19) United States
(12) Patent Application Publication
(10) Pub. No.: US 2010/0047664 A1
(43) Pub. Date: Feb. 25, 2010

(54) FLUID TRANSFER DEVICE AND FUEL CELL COMPRISING SAME

(76) Inventors: Masato Nishikawa, Osaka (JP); Tatsuyuki Nakagawa, Osaka (JP); Hitoshi Kihara, Osaka (JP); Kentaro Nakamura, Kanagawa (JP)

Correspondence Address: MCDERMOTT WILL & EMERY LLP, 600 13TH STREET, N.W., WASHINGTON, DC, 20005-3096, US

(21) Appl. No.: 12/530,702

(22) PCT Filed: Mar. 18, 2008
(86) PCT No.: PCT/JP2008/054937

§ 371 Date: Sep. 10, 2009

(30) Foreign Application Priority Data
Mar. 30, 2007 (JP) 2007-091845
Mar. 5, 2008 (JP) 2008-054197

(51) Int. Cl. H01M 8/04

(52) U.S. Cl. 429/34

(57) ABSTRACT

A fluid transfer device having a simple structure and smaller size than conventional ones is provided.

In the fluid transfer device according to the present invention, a vibrating plate 2 is placed facing a predetermined flow path, a flow path forming plate 4 is interposed in the flow path, at least one flow path hole 41 opens on the flow path forming plate 4, a gap is provided between the vibrating plate 2 and the flow path forming plate 4 so that static pressure is generated between the vibrating plate 2 and the flow path forming plate 4 when the vibrating plate 2 is vibrated in an ultrasonic range, and fluid is transferred by the static pressure.

### FIELD OF THE INVENTION

The present invention relates to a fluid transfer device transferring fluid by vibrating a vibrating plate in an ultrasound range, and a fuel cell comprising the fluid transfer device.

### DESCRIPTION OF RELATED ART

In recent years, it has been considered to install a fuel cell as a power source in small electronic devices such as a portable telephone.

Fuel cells have high energy conversion efficiency and do not generate any harmful materials in the power generation reaction, and therefore, have attracted attention as an energy source for a variety of electric devices. In a fuel cell, an air pole and a fuel pole are disposed on both sides of an electrolytic membrane to form a membrane electrode assembly (MEA), and an oxidation gas such as air or oxygen is supplied to the air pole side of the MEA, while a fuel such as methanol is supplied to the fuel pole side of the MEA being maintained in a gas or liquid state to generate electric power.

In order to install the fuel cell in a small electronic device, it is required to downsize a fluid transfer device for supplying air and fuel to the air pole and the fuel pole of the fuel cell.

Conventionally, as a small fluid transfer device, it has been suggested one transferring fluid utilizing surface acoustic wave (for example, see Japanese Laid-Open Patent Publication No. 2004-14192), one transferring fluid utilizing vibration of a fan like member (for example, see Japanese Laid-Open Patent Publication No. 2004-214128 and Japanese Laid-Open Patent Publication No. 2002-184430), one transferring fluid utilizing a diaphragm type piezoelectric vibrator (for example, see Japanese Laid-Open Patent Publication No. 63-162980), and one transferring fluid utilizing acoustic streaming (for example, see Japanese Laid-Open Patent Publication No. 63-72295).

### DISCLOSURE OF THE INVENTION

### Problems to be Solved by the Invention

However, in any of conventional fluid transfer devices, it is difficult to downsize the devices to such a degree that the devices can be installed in small electronic devices along with fuel cells, and none of them has been put to practical use. An object of the present invention is to provide a fluid transfer device smaller than conventional ones and having an easy structure.

### Means for Solving the Problem

As the results of intensive studies to achieve the above described object, the inventors of the present invent ion obtained the idea from an ultrasonic pump, and succeeded in developing a small fluid transfer device.

The ultrasonic pump is formed, for example, by immersing a tip part of a cylindrical nozzle 101 in a liquid tank 100 and connecting a base end part of the nozzle 101 to an ultrasonic oscillation device 103, as shown in FIG. 31. Liquid in the liquid tank 100 is pumped by the nozzle 101 when the ultrasonic oscillation in a vertical direction is provided to the nozzle 101, and a greater discharge amount can be obtained by arranging a plate 102 opposed to the tip part of the nozzle 101 and providing a gap G (for example, Japanese Journal of Applied Physics Vol. 43 No. 5 B, 2004 “An Ultrasonic Suction Pump with No Physically Moving Parts”, Japanese Journal of Applied Physics Vol. 44 No. 6 B, 2005 “Characteristics of Ultrasonic Suction Pump Without Moving Parts”, Science Direct Ultrasonics 44(2006)).

In a first fluid transfer device according to the present invention, a vibrating plate is placed facing a predetermined flow path, a flow path forming plate is interposed in the flow path, at least one flow path hole opens on the flow path forming plate, a gap is provided between the vibrating plate and the flow path forming plate so that static pressure is generated between the vibrating plate and the flow path forming plate when the vibrating plate is vibrated in an ultrasonic range, and fluid is transferred by the static pressure.

The inventors of the present invention confirmed by way of experiment a phenomenon in which when the vibrating plate is vibrated in the ultrasonic range in the first fluid transfer device of the present invention described above, the fluid flows in the flow path from an inlet side of the flow path hole facing the vibrating plate toward an outlet side opposite to the vibrating plate. The principle of the phenomenon is considered basically the same as the ultrasonic pump shown in FIG. 31 described above, and said gap in the present invention corresponds to the gap G of the ultrasonic pump shown in FIG. 31.

In other words, the gap fluctuates due to the vibration of the vibrating plate. Of one cycle of the vibration, in a half cycle where the gap becomes smaller, the fluid contracts to increase the elastic coefficient, while in a half cycle where the gap becomes greater, the fluid extends to decrease the elastic coefficient, and therefore, wave shape of the dynamic pressure variation accompanied with the vibration varies between the half cycle where the gap becomes smaller and the half cycle where the gap becomes greater. As a result, finite static pressure is generated as a time average value, and the fluid is considered to be transferred by this static pressure.

In particular, the vibrating plate and the flow path forming plate are placed in parallel with the flow path or perpendicular to the flow path.

Also, in particular, the gap between the vibrating plate and the flow path forming plate is set smaller than a gap between the flow path forming plate and the flow path wall placed on a side opposite to the vibrating plate across the flow path forming plate.

Thereby the fluid flows in the flow path hole of the flow path forming plate from the inlet facing the vibrating plate toward the outlet facing the flow path wall.

A projecting piece projects from the vibrating plate toward the flow path hole of the flow path forming plate. Thereby accelerated is the flow of the fluid from the inlet toward the outlet of the flow path hole of the flow path forming plate.

In another particular configuration, a plurality of flow path holes open on the flow path forming plate. Of the plurality of flow path holes, a flow path hole located on the downstream side of the flow path has a greater inner diameter than that of a flow path hole located on the upstream side of the flow path.

Alternatively, the gap between the flow path forming plate and the flow path wall disposed on the side opposite to the vibrating plate across the flow path forming plate increases from the upstream side toward the downstream side of the flow path.

Thereby the flow of the fluid from the upstream side toward the downstream side of the flow path is accelerated.

In a further particular configuration, the vibrating plate is made of a material such that acoustic impedance decreases continuously or in a phased manner from the upstream side toward the downstream side of the flow path. Thereby reflectance ratio of vibration energy passing through the fluid in the flow path and the flow path wall decreases from the upstream side toward the downstream side of the flow path.

Alternatively, the vibrating plate is formed so that its thickness becomes thinner continuously or in a phased manner from the upstream side toward the downstream side of the flow path. Thereby the vibration amplitude increases from the upstream side toward the downstream side of the flow path.

Alternatively, the plurality of flow path holes opening on the flow path forming plate are disposed so that the distance between each other gradually increases from the upstream side toward the downstream side of the flow path.

According to these particular configurations, the flow of the fluid from the upstream side toward the downstream side of the flow path is accelerated.

In a second fluid transfer device of the present invention, a vibrating plate is interposed in a predetermined flow path, at least one flow path hole opens on the vibrating plate, a gap is provided between the vibrating plate and a flow path wall opposed to the vibrating plate so that static pressure is generated between the vibrating plate and the flow path wall when the vibrating plate is vibrated in an ultrasonic range, and fluid is transferred by the static pressure.

The inventors of the present invention confirmed by way of experiment a phenomenon in which when the vibrating plate is vibrated in the ultrasonic range in the second fluid transfer device of the present invention described above, the fluid flows in the flow path from an inlet side toward an outlet side of the flow path hole. The principle of the phenomenon is considered basically the same as the ultrasonic pump shown in FIG. 31 described above, and said gap in the present invention corresponds to the gap G of the ultrasonic pump shown in FIG. 31.

In other words, the gap fluctuates due to the vibration of the vibrating plate. Of one cycle of the vibration, in a half cycle where the gap becomes smaller, the fluid contracts to increase the elastic coefficient, while in a half cycle where the gap becomes greater, the fluid extends to decrease the elastic coefficient, and therefore, wave shape of the dynamic pressure accompanied with the vibration varies between the half cycle where the gap becomes smaller and the half cycle where the gap becomes greater. As a result, finite static pressure is generated as a time average value, and the fluid is considered to be transferred by this static pressure.

In a particular configuration, the vibrating plate and the flow path wall are placed in parallel with the flow path or perpendicular to the flow path.

Also, in particular, the gap between the vibrating plate and the flow path wall is set smaller than a gap between the vibrating plate and another flow path wall disposed on the side opposite to the flow path wall across the vibrating plate.

Thereby the fluid flows in the flow path hole of the vibrating plate from the inlet facing the flow path wall toward the outlet facing the other flow path wall.

A projecting piece projects from the flow path wall toward the flow path hole of the vibrating plate. Thereby accelerated is the flow of the fluid from the inlet toward the outlet of the flow path hole of the vibrating plate.

In another particular configuration, a plurality of flow path holes open on the vibrating plate. Of the plurality of flow path holes, a flow path hole located on the downstream side of the flow path has a greater inner diameter than that of a flow path hole located on the upstream side of the flow path.

Alternatively, the gap between the vibrating plate and the flow path wall placed on the side opposite to the flow path wall across the vibrating plate increases from the upstream side toward the downstream side of the flow path.

Thereby accelerated is the flow of the fluid from the inlet side toward the outlet side of the flow path hole.

In a further particular configuration, the vibrating plate is made of a material such that acoustic impedance decreases continuously or in a phased manner from the upstream side toward the downstream side of the flow path. Thereby reflectance ratio between the vibration plate and the fluid in the flow path decreases from the upstream side toward the downstream side of the flow path.

Alternatively, the vibrating plate is formed so that its thickness becomes thinner continuously or in a phased manner from the upstream side toward the downstream side of the flow path. Thereby the vibration amplitude increases from the upstream side toward the downstream side of the flow path.

Alternatively, the plurality of flow path holes opening on the vibrating plate are disposed so that the distance between each other gradually increases from the upstream side toward the downstream side of the flow path.

According to these particular configurations, accelerated is the flow of the fluid from the upstream side toward the downstream side of the flow path.

Also, a fuel cell according to the present invention comprises the fluid transfer device described above, and in the fuel cell, the membrane-electrode assembly is provided along a flow path defined in the fluid transfer device.

According to the fuel cell, required fluid is supplied to the membrane-electrode assembly by the fluid transfer device. It is possible to realize the downsizing of electronic devices by installing this fuel cell in the electronic devices.

### Effects of the Invention

According to the present invention, it is possible to realize a fluid transfer device and a fuel cell smaller than conventional ones and having an easy structure.

### BRIEF DESCRIPTION OF THE DRAWINGS

FIG. 1 is a cross-sectional view of a first fluid transfer device of the present invention;

FIG. 2 is a horizontal sectional view of a flow path forming plate of the first fluid transfer device;

FIG. 3 is a cross-sectional view of an example in which projecting pieces are provided;

FIG. 4 are views explaining a vibration mode to be generated on a vibrating plate;

FIG. 5 is a cross-sectional view showing an example in which inner diameters of flow path holes are altered;

FIG. 6 is a cross-sectional view showing an example in which a gap on an outlet side increases toward downstream;

FIG. 7 are views explaining the vibration mode to be generated on a circular vibrating plate;

FIG. 8 is a cross-sectional view showing an example in which compressional wave is generated on the vibrating plate;

FIG. 9 is a vertical longitudinal sectional view showing a configuration in which the flow path forming plate is provided perpendicular to the flow path;

FIG. 10 is a vertical transverse sectional view of the configuration;

FIG. 11 is a horizontal sectional view of the configuration;

FIG. 12 are horizontal sectional views showing other configurations in relation to the vibrating plate and a piezoelectric element;

FIG. 13 is a cross-sectional view showing the location of a fluid inlet;

FIG. 14 is a cross-sectional view of an example in which a main part of the fluid transfer device is placed on the downstream side of the flow path;

FIG. 15 is a cross-sectional view of a second fluid transfer device of the present invention;

FIG. 16 is a plain view of a vibrating plate of the second fluid transfer device;

FIG. 17 is a cross-sectional view of an example in which projecting piece are provided;

FIG. 18 are views explaining a vibration mode to be generated on the vibrating plate;

FIG. 19 is a cross-sectional view showing an example in which inner diameters of flow path holes are altered;

FIG. 20 is a cross-sectional view showing an example in which a gap on an outlet side increases toward downstream;

FIG. 21 are views explaining the vibration mode to be generated on a circular vibrating plate;

FIG. 22 is a cross-sectional view showing an example in which compressional wave is generated on the vibrating plate;

FIG. 23 is a vertical longitudinal sectional view showing a configuration in which the vibrating plate is provided perpendicular to the flow path;

FIG. 24 is a vertical transverse sectional view of the configuration;

FIG. 25 is a horizontal sectional view of the configuration;

FIG. 26 is a vertical longitudinal sectional view of a configuration provided with a projecting piece;

FIG. 27 is a horizontal sectional view of the configuration;

FIG. 28 are cross-sectional views showing shapes of the flow path hole;

FIG. 29 are horizontal sectional views showing other configurations in relation to the vibrating plate and a piezoelectric element;

FIG. 30 are cross-sectional views of an example in which a main part of the fluid transfer device is placed on the downstream side of the flow path; and

FIG. 31 is a cross-sectional view of a conventional ultrasonic pump.

### EXPLANATION OF REFERENCES

1. MEA

2. Vibrating plate

3. Piezoelectric element

4. Flow path forming plate

41. Flow path hole

5. Casing

7. Projecting piece

8. Vibrating plate

9. Plate

### BEST MODE FOR CARRYING OUT THE INVENTION

An embodiment of the present invention in a fluid transfer device in a fuel cell is to be described in detail below with reference to the drawings.

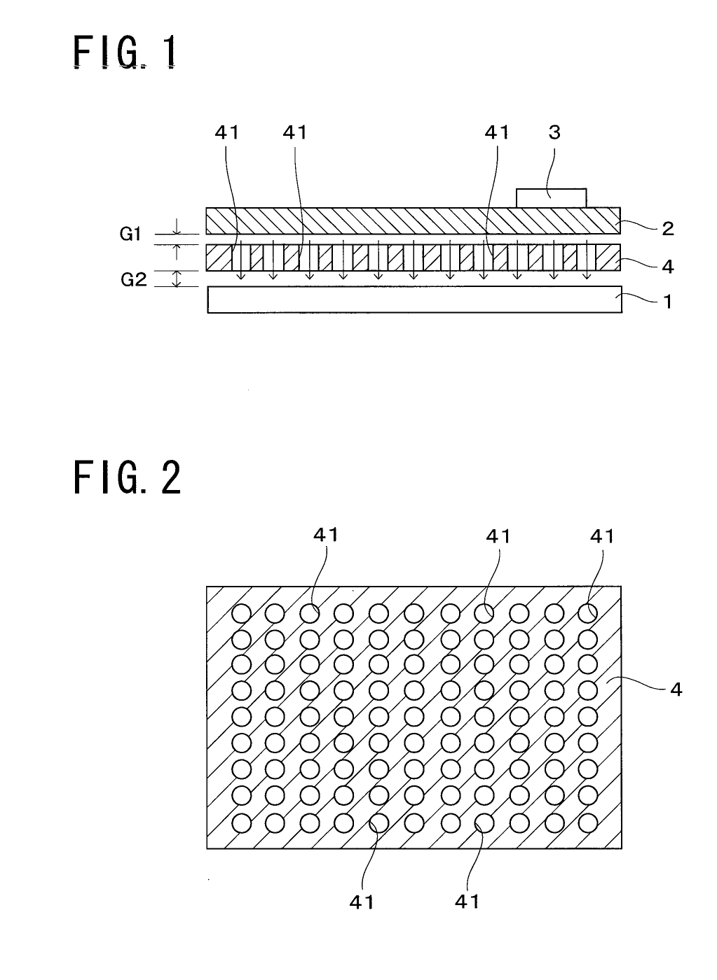

As shown in FIG. 1, in a first fluid transfer device of the present invention, a flat plate-like vibrating plate 2 is placed in parallel with and opposed to a surface of a membrane-electrode assembly 1 (hereinafter referred to as MEA 1) to define a flow path between the MEA 1 and the vibrating plate 2, and a flat plate-like flow path forming plate 4 is interposed in the flow path in a parallel attitude.

On a surface of the vibrating plate 2, as shown in FIGS. 4a and 4b, a piezoelectric element 3 is placed to provide a vibration in an ultrasound range to the vibrating plate 2. Thereby bending wave is generated on the vibrating plate 2 in a plane perpendicular to the flow path as indicated by a dotted line in FIG. 4a.

On the flow path forming plate 4, a plurality of flow path holes 41 spreading across whole area on an opposing surface to the flow path open as shown in FIG. 2. Also, as shown in FIG. 1, a gap G1 between the flow path forming plate 4 and an opposing surface of the vibrating plate 2 is set smaller than a gap G2 between the flow path forming plate 4 and an opposing surface of the MEA 1. It is preferable to dispose the flow path holes 41 opposed to locations of loops of the bending wave.

Thereby in the flow path between the MEA 1 and the vibrating plate 2, as indicated by arrows in FIG. 1, formed is a flow of the fluid from the vibrating plate 2 side through the flow path holes 41 of the flow path forming plate 4 toward the MEA 1 side.

As a result, the flow of the fluid along a surface of the MEA 1 is formed and the fluid is supplied to the surface of the MEA 1, whereby the MEA 1 generates electric power.

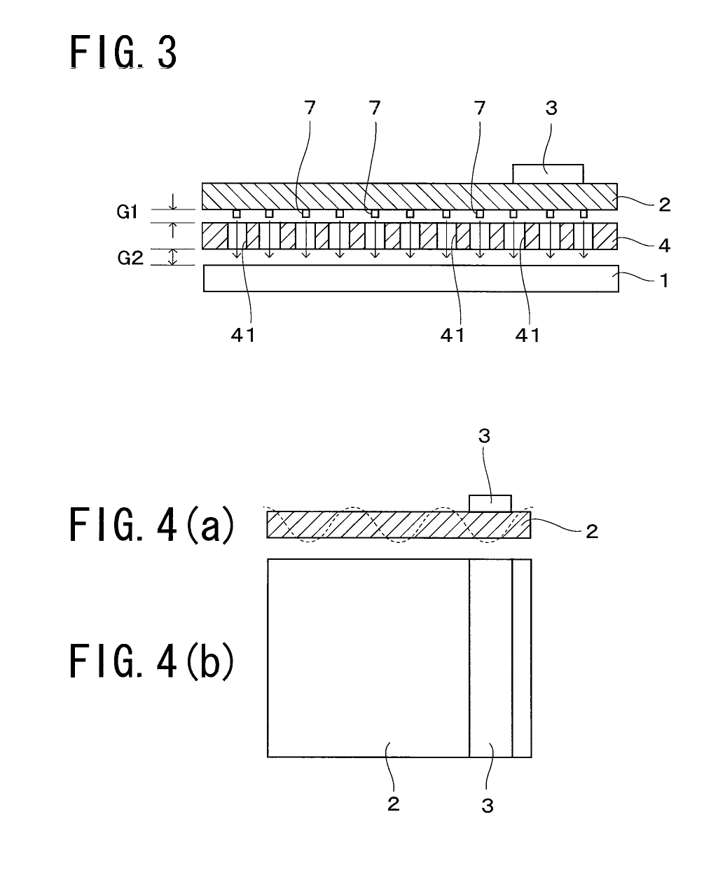

FIG. 3 shows an example in which a surface of the vibrating plate 2 in the fluid transfer device shown in FIG. 1 is provided with a plurality of projecting pieces 7 projecting toward the flow path holes 41 of the flow path forming plate 4. Thereby accelerated is the flow of the fluid from the vibrating plate 2 side through the flow path holes 41 of the flow path forming plate 4 toward the MEA 1 side.

As a result, the flow of the fluid along the surface of the MEA 1 is formed and the fluid is supplied to the surface of the MEA 1, whereby the MEA 1 generates electric power.

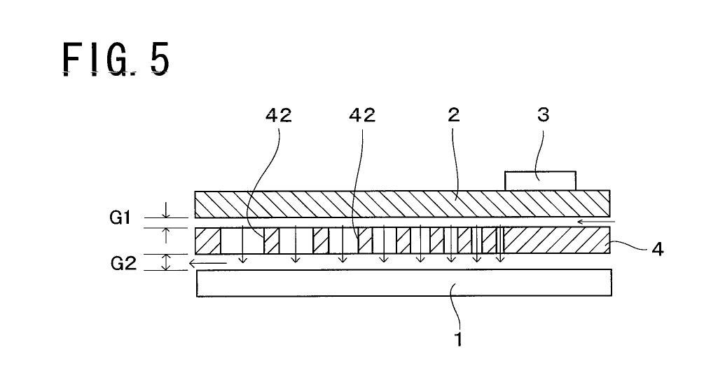

In a fluid transfer device shown in FIG. 5, a gap G1 between the flow path forming plate 4 and an opposing surface of the vibrating plate 2 is set smaller than a gap G2 between the flow path forming plate 4 and an opposing surface of the MEA 1, and, of a plurality of flow path holes 42 opening on the flow path forming plate 4, a flow path hole 42 located on the downstream side of the flow path has a greater inner diameter than that of a flow path hole 42 located on the upstream side of the flow path.

Thereby accelerated is the flow of the fluid from the upstream side toward the downstream side of the flow path, and an amount of the flow increases.

Also, since the flow of the fluid on the MEA 1 side in a discharge direction can be controlled, it is possible to form the flow of the fluid effectively.

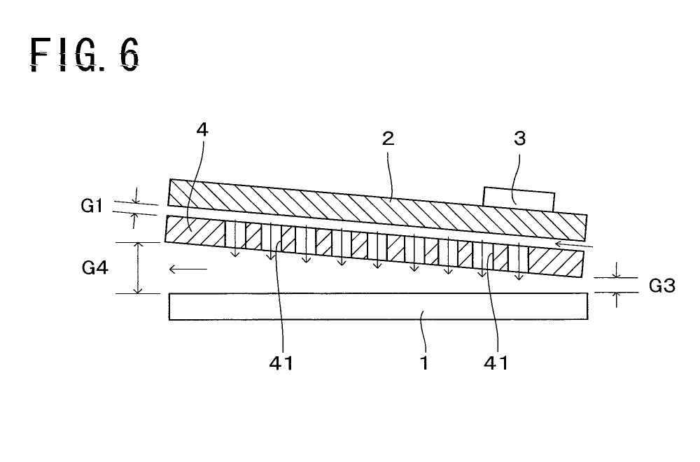

In a fluid transfer device shown in FIG. 6, the vibrating plate 2 and the flow path forming plate 4 are attached in a diagonal manner, a gap G4 on the downstream side between the flow path forming plate 4 and the opposing surface of the MEA 1 is set greater than a gap G3 on the upstream side, and these gaps G3 and G4 are set greater than the gap G1 between the flow path forming plate 4 and the opposing surface of the vibrating plate 2.

Thereby accelerated is the flow of the fluid from the upstream side toward the downstream side of the flow path, and the amount of the flow increases.

Also, since the flow of the fluid on the MEA 1 side in the discharge direction can be controlled, it is possible to form the flow of the fluid effectively.

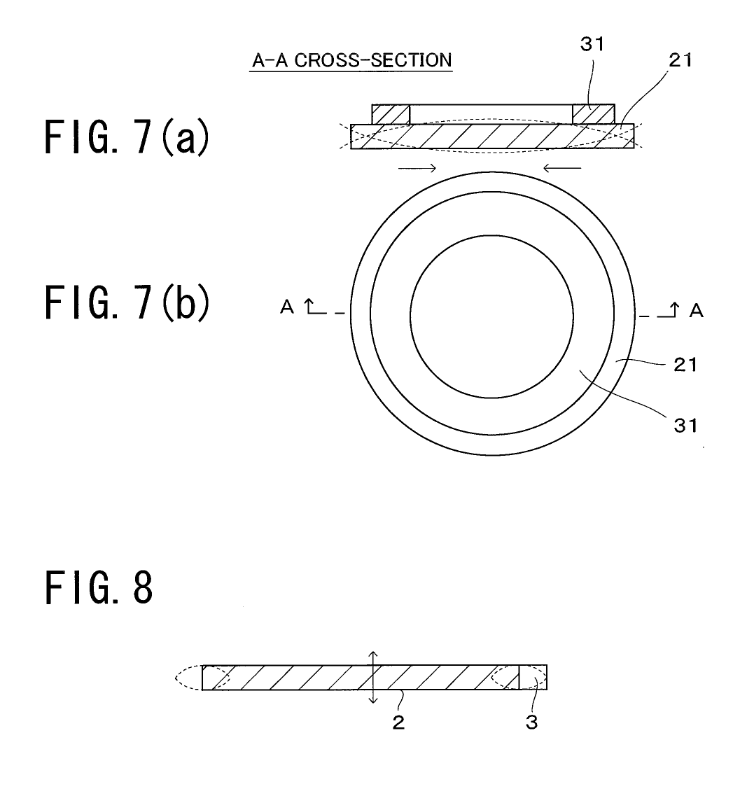

FIGS. 7a and 7b show a fluid transfer device in which a ring-shaped piezoelectric element 31 is placed on a surface of a circular vibrating plate 21 and the bending vibration is provided to the vibrating plate 21 as indicated by dotted lines in the figure. According to this fluid transfer device, it is possible to generate a flow of the fluid from outside toward inside of the vibrating plate 21 as indicated by solid line arrows in the figure, for example.

Also, FIG. 8 shows a structure in which the piezoelectric element 3 is placed on a side surface of the vibrating plate 2 and compressional wave in a direction perpendicular to the vibrating plate 2 is generated. It is also possible in this structure to generate a flow in the flow path in a single direction in a similar manner.

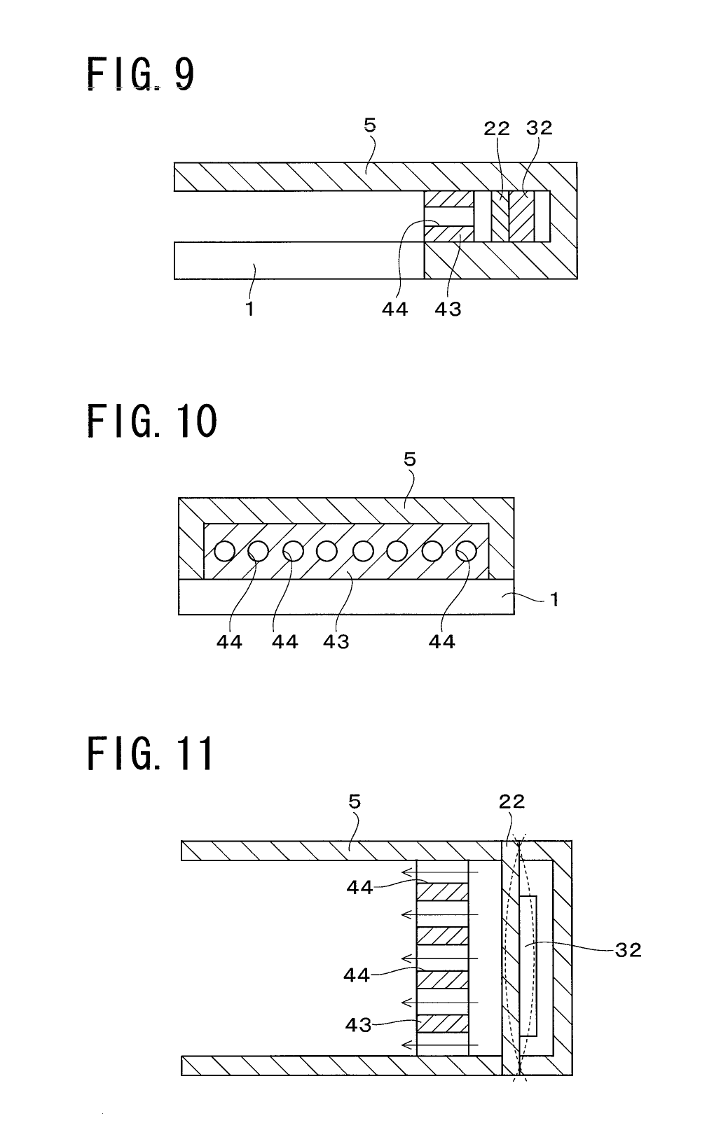

In a fluid transfer device shown in FIG. 9, a casing 5 is placed covering the surface of the MEA 1, a flow path is defined between the MEA 1 and an opposing surface of the casing 5, a vibrating plate 22 is placed perpendicular to the flow path on an end part of the flow path, and, in the flow path, a flow path forming plate 43 is placed perpendicular to the flow path. A piezoelectric element 32 is attached to a back surface of the vibrating plate 22.

As shown in FIG. 10, on the flow path forming plate 43, a plurality of flow path holes 44 open across whole area on an opposing surface to the vibrating plate 22.

In the fluid transfer device described above, by providing the bending vibration to the vibrating plate 22 as shown in FIG. 11, the fluid is transferred from a fluid inlet (not shown) provided on an end part of the casing 5 on the vibrating plate 22 side through the flow path holes 44 of the flow path forming plate 43 toward a fluid outlet provided on the other end part of the casing 5.

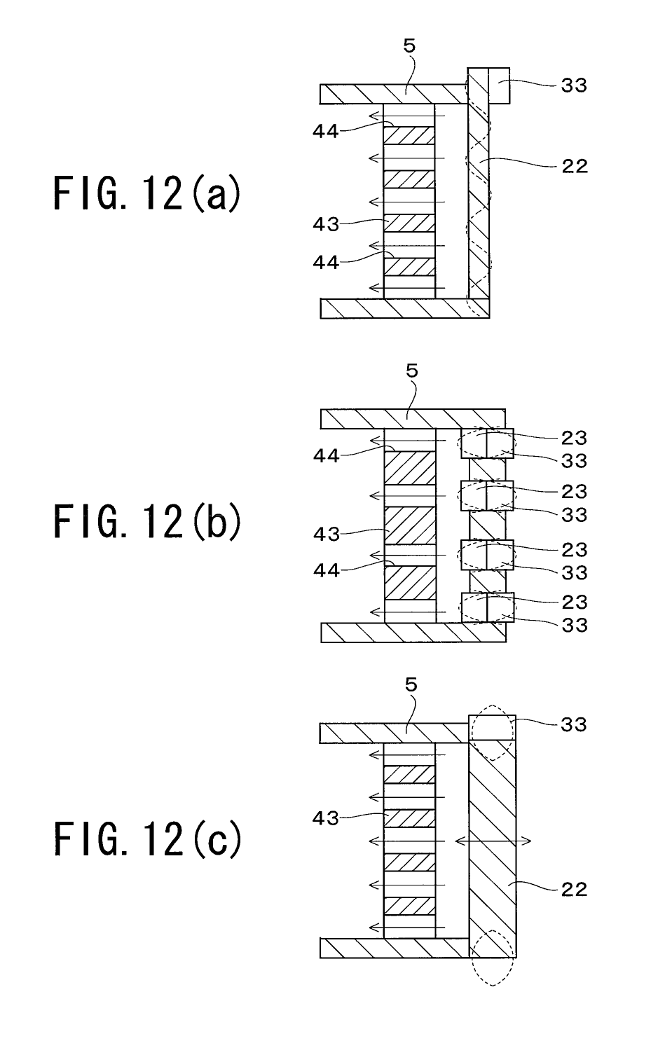

In the fluid transfer device described above, not limited to the structure in which a primary vibration mode is generated on the vibrating plate 22, it is also possible to place the piezoelectric element 33 on the end part of the vibrating plate 22 as shown in FIG. 12a to generate a higher-order vibration mode on the vibrating plate 22 as indicated by a dotted line in the figure. Here, it is possible to transfer the fluid effectively by a structure in which the locations of the loops of the vibration generated on the vibrating plate 22 correspond to the flow path holes 44 of the flow path forming plate 43 respectively.

Also, as shown in FIG. 12b, it is possible to arrange a plurality of vibrating plates 23 and place the piezoelectric element 33 on each vibrating plate 23 to thereby generate the higher-order vibration mode. Here, it is possible to transfer the fluid effectively by disposing each vibrating plate 23 opposed to each flow path holes 44 of the flow path forming plate 43.

Further, as shown in FIG. 12c, it is possible to adopt a structure in which the piezoelectric element 33 is placed on the side surface of the vibrating plate 22 and the compressional wave is generated on the vibrating plate 22 in a plane perpendicular to the flow path.

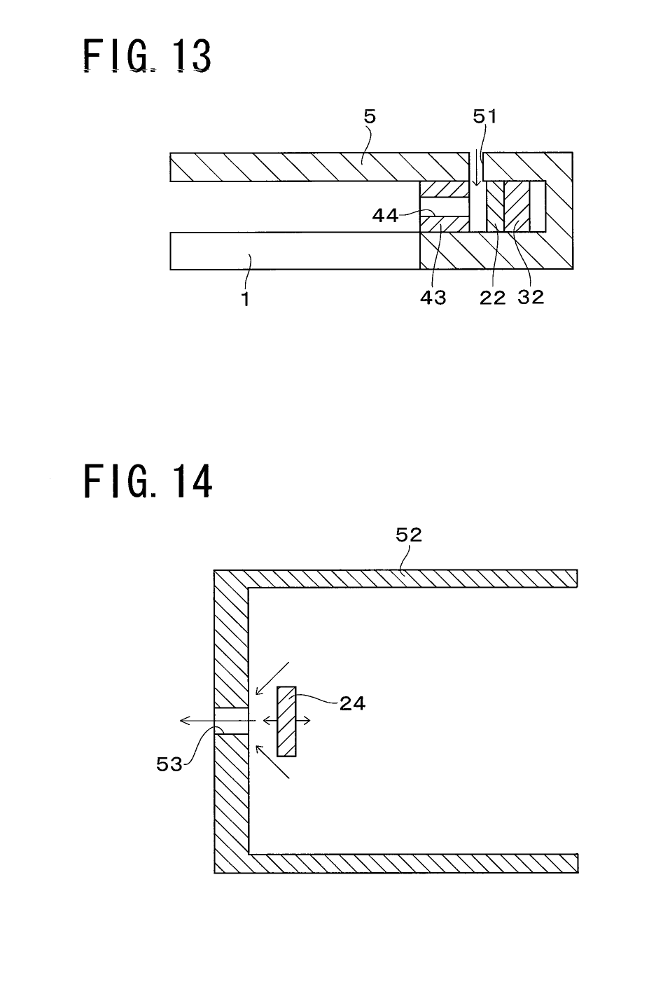

FIG. 13 shows an example in which a fluid inlet 51 opens on the casing 5. The fluid inlet 51 opens toward the flow path upstream part between the flow path forming plate 43 and the vibrating plate 22.

FIG. 14 shows an example in which a vibrating plate 24 is placed on the downstream side of the flow path defined by a casing 52 and flow path holes 53 open on the casing 52 opposed to the vibrating plate 24. It is possible to dispose the main part of the fluid transfer device on the downstream side of the flow path in this manner.

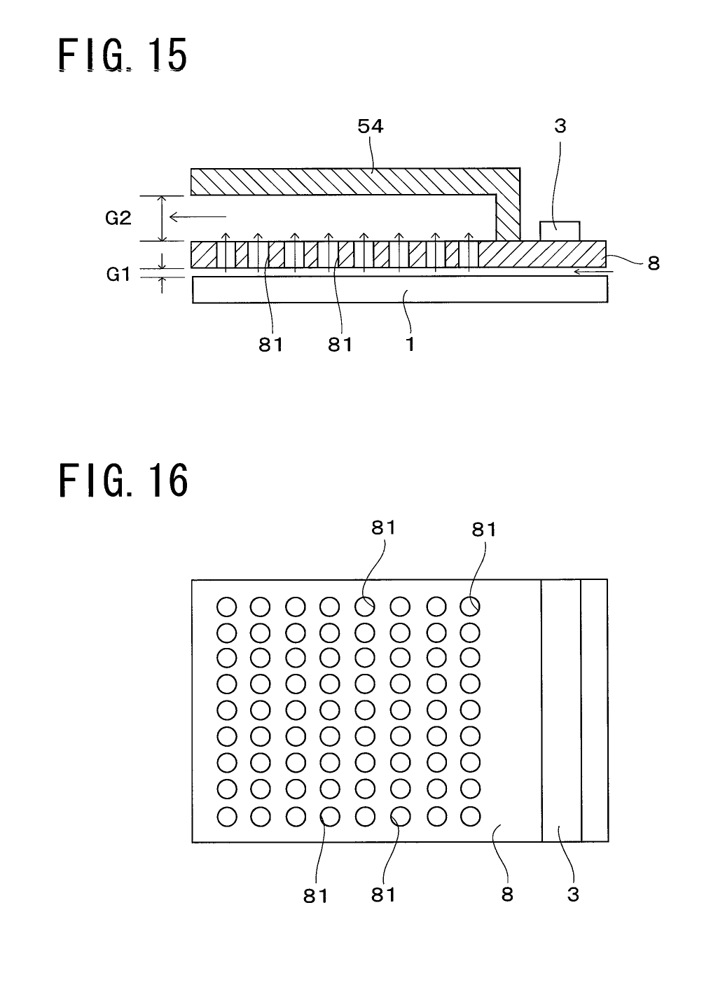

In a second fluid transfer device of the present invention, as shown in FIG. 15, a casing 54 is placed opposed to the surface of the MEA 1 to define a flow path between the MEA 1 and the casing 54, and a flat plate-like vibrating plate 8 is interposed in the flow path in a parallel attitude.

The piezoelectric element 3 is placed on a surface of the vibrating plate 8 as shown in FIGS. 18a and 18b, and vibration in the ultrasound range is provided to the vibrating plate 8. Thereby the bending vibration is generated on the vibrating plate 8 in a plane parallel to the flow path as indicated by a dotted line in the FIG. 18a.

A plurality of flow path holes 81 spreading across whole area on an opposing surface to the flow path opens on the vibrating plate 8 as shown in FIG. 16. Also, as shown in FIG. 15, a gap G1 between the MEA 1 and an opposing surface of the vibrating plate 8 is set smaller than a gap G2 between the vibrating plate 8 and an opposing surface of the casing 54.

Thereby in the flow path between the MEA 1 and the casing 54, as indicated by arrows in FIG. 15, formed is a flow of the fluid from the MEA 1 side through the flow path holes 81 of the vibrating plate 8 toward the casing 54.

As a result, the flow of the fluid along the surface of the MEA 1 is formed and the fluid is supplied to the surface of the MEA 1, whereby the MEA 1 generates electric power.

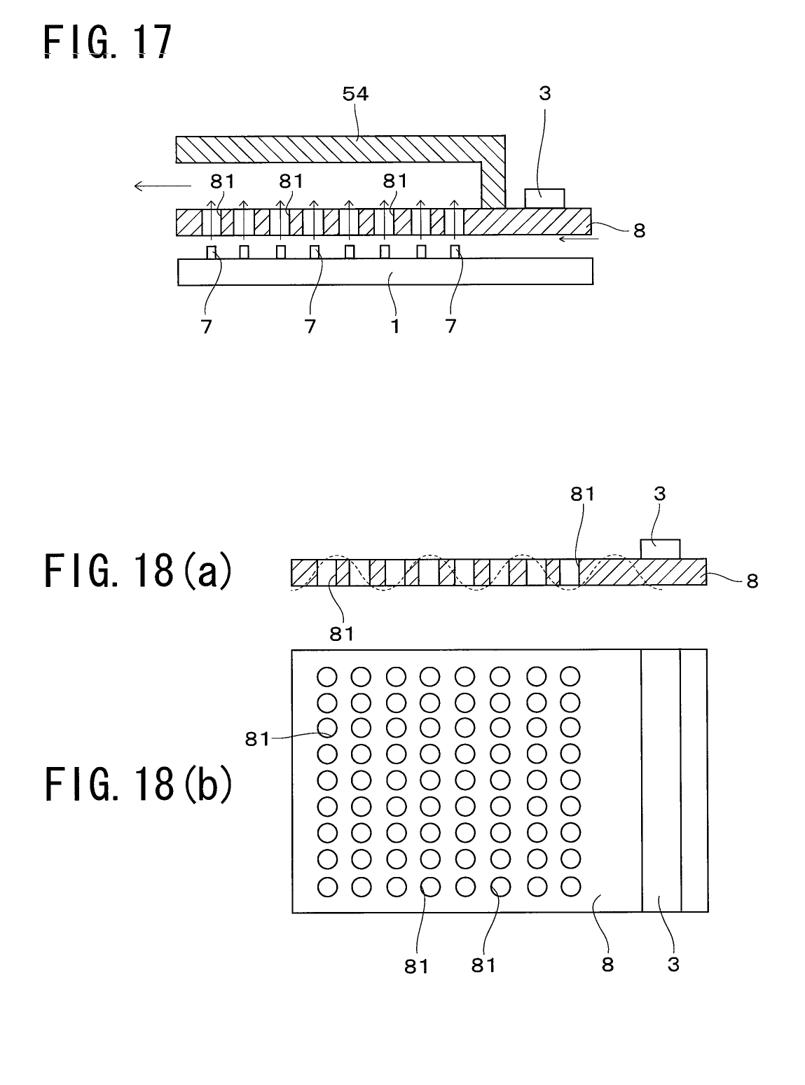

FIG. 17 shows an example in which a surface of the MEA 1 shown in FIG. 15 is provided with a plurality of projecting pieces 7 projecting toward the flow path holes 81 of the vibrating plate 8 respectively. Thereby accelerated is the flow of the fluid from the MEA 1 side through the flow path holes 81 of the vibrating plate 8 toward the casing 54 side.

As a result, the flow of the fluid along the surface of the MEA 1 is formed and the fluid is supplied to the surface of the MEA 1, whereby the MEA 1 generates electric power.

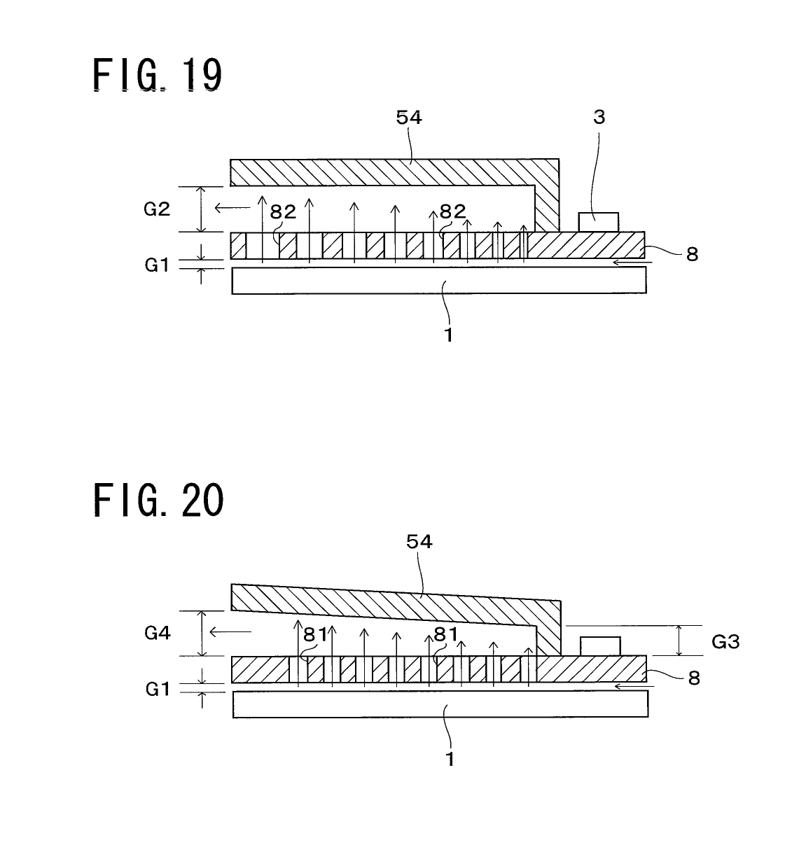

In a fluid transfer device shown in FIG. 19, a gap G1 between the MEA 1 and the opposing surface of the vibrating plate 8 is set smaller than a gap G2 between the vibrating plate 8 and an opposing surface of the casing 54, and, of a plurality of flow path holes 82 opening on the vibrating plate 8, a flow path hole 82 located on the downstream side of the flow path has a greater inner diameter than that of a flow path hole 82 located on the upstream side of the flow path.

Thereby accelerated is the flow of the fluid from the upstream side toward the downstream side of the flow path, and the amount of the flow increases.

Also, since the flow of the fluid on the MEA 1 side in the discharge direction can be controlled, it is possible to form the flow of the fluid effectively.

In a fluid transfer device shown in FIG. 20, the casing 54 is attached in a diagonal manner, a gap between the vibrating plate 8 and the opposing surface of the casing 54 is set greater than the gap G1 between the MEA 1 and the opposing surface of the vibrating plate 8, and the gap G4 on the downstream side is set greater than the gap G3 on the upstream side of the flow path.

Thereby accelerated is the flow of the fluid from the upstream side toward the downstream side of the flow path, and the amount of the flow increases.

Also, since the flow of the fluid on the MEA 1 side in the discharge direction can be controlled, it is possible to form the flow of the fluid effectively.

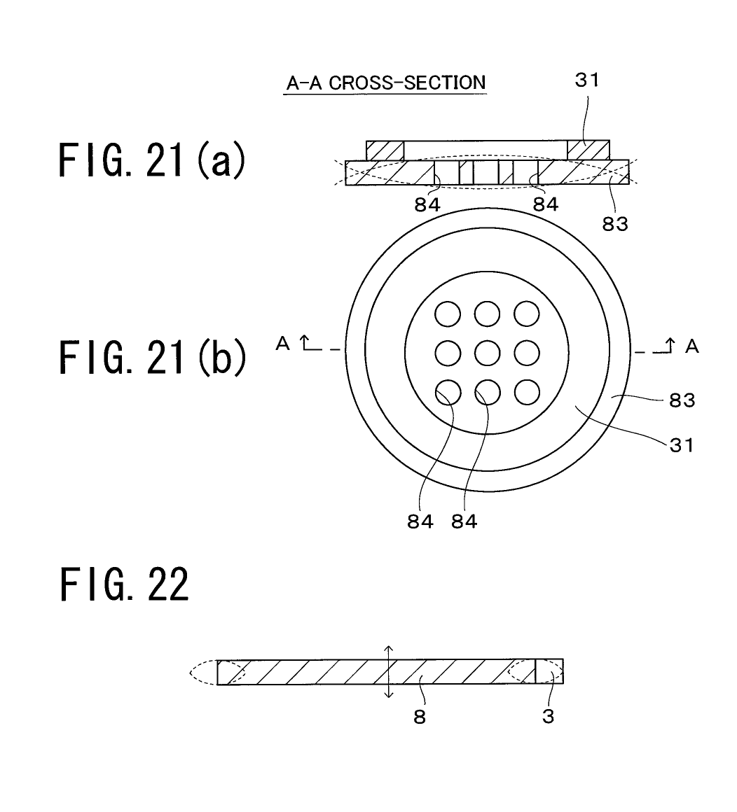

FIGS. 21a and 21b show a fluid transfer device in which the ring-shaped piezoelectric element 31 is placed on a surface of a circular vibrating plate 83 having a plurality of flow path holes 84 and the bending vibration is provided to the vibrating plate 83 as indicated by dotted lines in the figure. According to this fluid transfer device, it is possible to generate a flow of the fluid, for example, from outer periphery side toward inner periphery side of the vibrating plate 83.

Also, FIG. 22 shows a structure in which the piezoelectric element 3 is placed on a side surface of the vibrating plate 8 and the compressional wave is generated in a direction perpendicular to the vibrating plate 8. It is also possible in this structure to generate a flow in the flow path in a single direction in a similar manner.

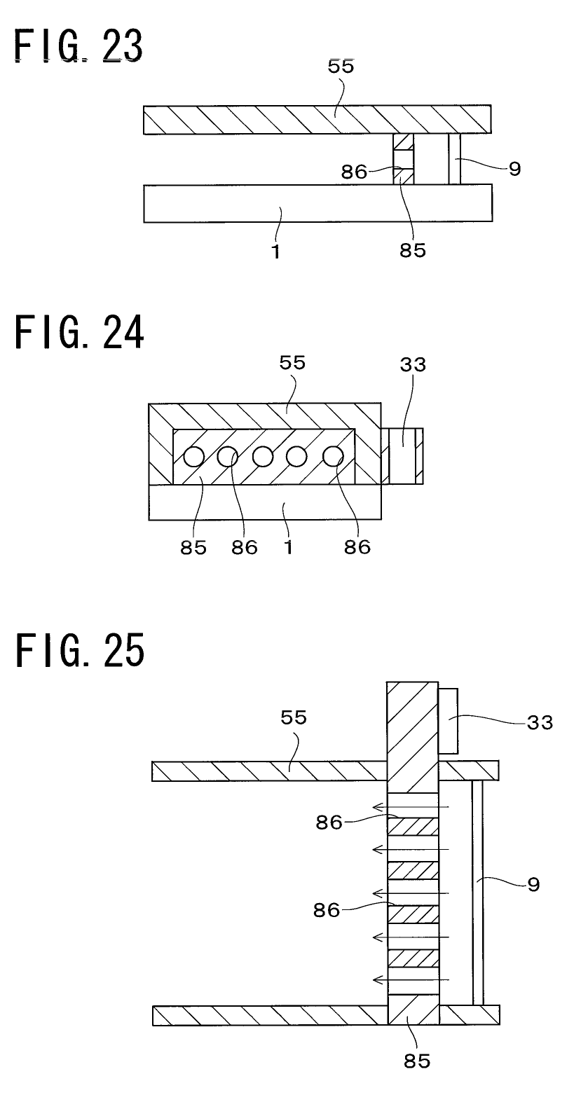

In a fluid transfer device shown in FIG. 23, a casing 55 is placed covering the surface of the MEA 1, a flow path is defined between the MEA 1 and an opposing surface of the casing 55, a plate 9 is placed perpendicular to the flow path on an end part of the flow path, and, in the flow path, a vibrating plate 85 is placed perpendicular to the flow path. The piezoelectric element 33 is attached to a back surface of the vibrating plate 85.

As shown in FIG. 24, on the vibrating plate 85, a plurality of flow path holes 86 open across whole area on an opposing surface to the plate 9.

In the fluid transfer device described above, by providing the bending vibration to the vibrating plate 85, the fluid is transferred from a fluid inlet (not shown) provided on an end part of the casing 55 on the plate 9 side through the flow path holes 86 of the vibrating plate 85 toward a fluid outlet provided on the other end part of the casing 55. It is preferable that the flow path holes 86 are disposed opposed to the positions of the loops of the bending vibration.

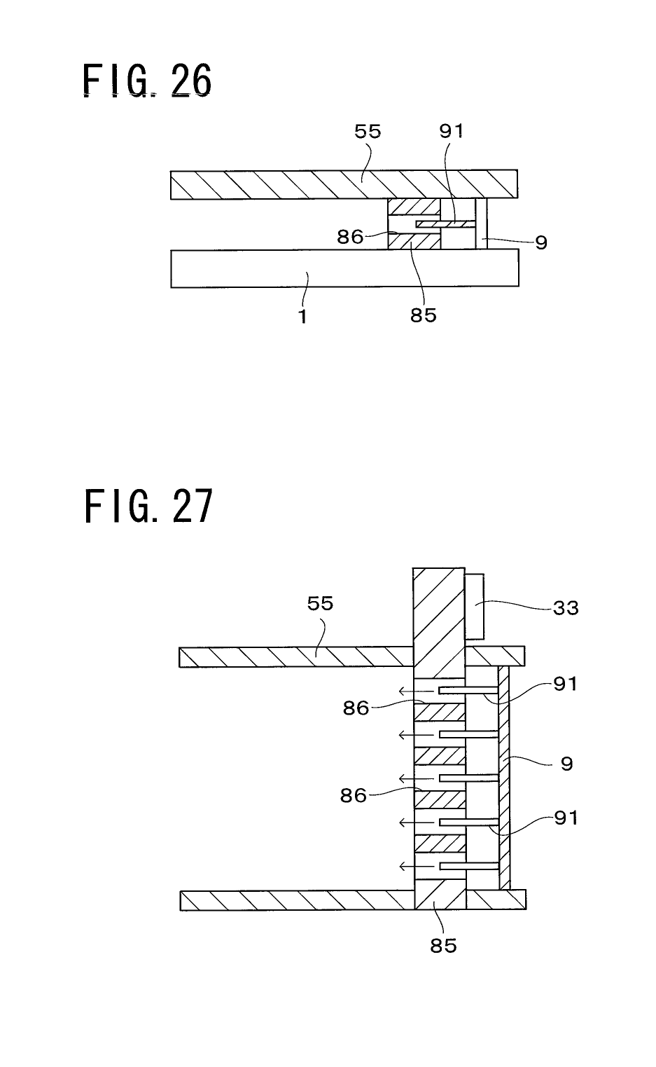

According to a structure in which, as shown in FIGS. 26 and 27, the plate 9 is provided with projecting parts 91 projecting toward flow path holes 86 of the vibrating plate 85 respectively, it is possible to form the flow of the fluid passing from the plate 9 side through the flow path holes 86 of the vibrating plate 85 regardless of the size of the gap between the vibrating plate 85 and an opposing surface of the plate 9.

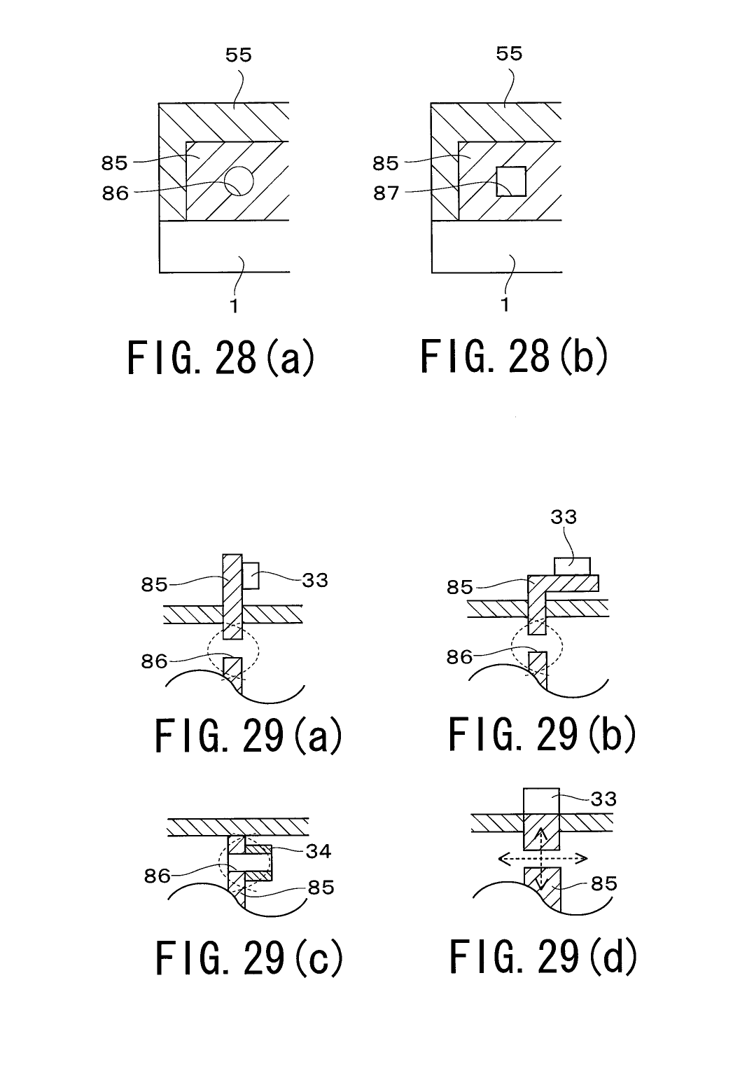

In the fluid transfer device described above, not limited to the structure in which circular flow path holes 86 open on the vibrating plate 85 as shown in FIG. 28a, it is possible to obtain equivalent effect by a structure in which rectangular flow path holes 87 open as shown in FIG. 28b.

Also, the vibration generated on the vibrating plate 85 may either be the primary vibration mode or the higher-order vibration mode as long as it is flexural vibration in which a loop is generated in the flow path holes 86 of the vibrating plate 85 as shown in FIGS. 29a and 29b.

Further, it is possible to adopt a structure in which a ring-shaped piezoelectric element 34 is attached to each flow path holes 86 of the vibrating plate 85 as shown in FIG. 29c to provide the higher order vibration to the vibrating plate 85.

Still further, it is possible to adopt a structure in which the piezoelectric element 33 is placed on an end surface of the vibrating plate 85 as shown in FIG. 29d to generate the bending vibration on the vibrating plate 85 in a plane perpendicular to the flow path.

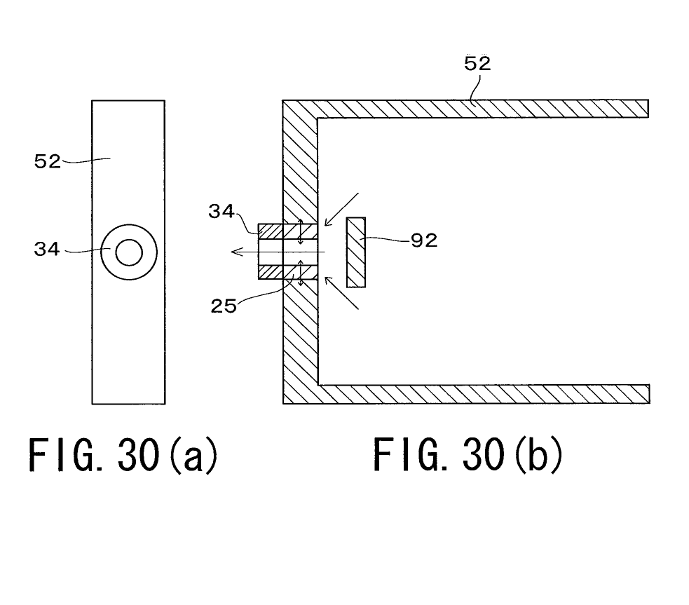

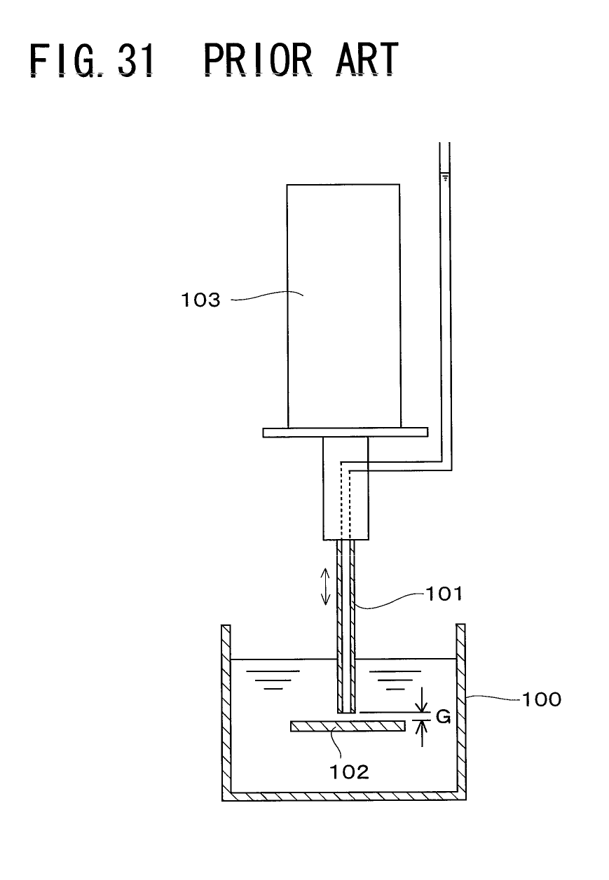

FIGS. 30a and 30b show an example in which a plate 92 is placed on the downstream side of the flow path defined by a casing 52, a ring-shaped vibrating plate 25 is attached to the casing 52, being opposed to the plate 92, and the ring-shaped piezoelectric element 34 is attached to the vibrating plate 25. It is possible to dispose the main part of the fluid transfer device on the downstream side of the flow path in this manner.

According to the fluid transfer device of the present invention described above, it is possible to make the fluid flow in a single direction with an easy structure in which the vibrating plate is set facing the flow path, the flow path holes are defined in the flow path, and gaps of the flow path holes on the inlet side and the outlet side are adjusted. Therefore, it is possible to realize a fluid transfer device with easy structure having a smaller number of members than conventional ones, thereby realizing downsizing and reduction in thickness of the fluid transfer device. Therefore, by adopting the fluid transfer device of the present invention in small electronic devices in which fuel cells are installed, it is possible to realize the downsizing and reduction in thickness of the whole small electronic devices.

In addition, in the fluid transfer device of the present invention, energy loss is small and therefore saving of the power consumption is possible. Further, the vibrating plate vibrates at an inaudible vibration frequency and therefore, it is possible to realize a very quiet small electronic device with small noise.

Each of the embodiments and exemplary structures described above are exemplifications in all points and should not be considered as limitation. The scope of the present invention is defined by claims, not the embodiments and explanation of exemplary structures described above, and further includes all alterations within the scope and meaning of the appended claims and equivalents.

For example, in the fluid transfer device shown in FIG. 1, when the material of the vibrating plate 2 is formed so that acoustic impedance decreases continuously or in a phased manner from the upstream side toward the downstream side of the flow path, it is possible to transfer the fluid more effectively. Also in the fluid transfer device shown in FIG. 15, when the material of the vibrating plate 8 is formed so that acoustic impedance decreases continuously or in a phased manner from the upstream side toward the downstream side of the flow path, it is possible to transfer the fluid more effectively.

Also, in the fluid transfer device shown in FIG. 1, when the device is formed so that the thickness of the vibrating plate 2 decreases continuously or in a phased manner from the upstream side toward the downstream side of the flow path, it is possible to transfer the fluid more effectively. In the fluid transfer device shown in FIG. 15, when the device is formed so that the thickness of the vibrating plate 8 decreases continuously or in a phased manner from the upstream side toward the downstream side of the flow path, it is possible to transfer the fluid more effectively in a similar manner.

Also, in the fluid transfer device shown in FIG. 1, when the device is formed so that the distance between the plurality of flow path holes 41 of the flow path forming plate 4 gradually increases from the upstream side toward the downstream side of the flow path, it is possible to transfer the fluid more effectively. In the fluid transfer device shown in FIG. 15, when the device is formed so that the distance between the plurality of flow path holes 81 of the vibrating plate 8 gradually increases from the upstream side toward the downstream side of the flow path, it is possible to transfer the fluid more effectively in a similar manner.

Further, the fuel cell of the present invention may be used as a power source of any electronic devices such as a portable telephone, a battery charger for charging a portable telephone or the like, an audio-video equipment such as a video camera or the like, a portable game machine, a navigational device, a handy cleaner, a household generator, an industrial generator, a car, and a robot.

What is claimed is:

1. A fluid transfer device wherein a vibrating plate is placed facing a predetermined flow path, a flow path forming plate is interposed in the flow path, at least one flow path hole opens on the flow path forming plate, a gap is provided between the vibrating plate and the flow path forming plate so that static pressure is generated between the vibrating plate and the flow path forming plate when the vibrating plate is vibrated in an ultrasonic range, and fluid is transferred by the static pressure.

2. The fluid transfer device according to claim 1, wherein the vibrating plate and the flow path forming plate are placed in parallel with the flow path.

3. The fluid transfer device according to claim 2, wherein the gap between the vibrating plate and the flow path forming plate is set smaller than a gap between the flow path forming plate and a flow path wall placed on a side opposite to the vibrating plate across the flow path forming plate.

4. The fluid transfer device according to claim 2 or 3, wherein a projecting piece projects from the vibrating plate toward the flow path hole of the flow path forming plate.

5. The fluid transfer device according to any one of claims 2 to 4, wherein a plurality of flow path holes opens on the flow path forming plate, and, of the plurality of flow path holes, a flow path hole located on a downstream side of the flow path has a greater inner diameter than that of a flow path hole located on an upstream side of the flow path.

6. The fluid transfer device according to claim 1, wherein the vibrating plate and the flow path forming plate are placed perpendicular to the flow path.

7. A fluid transfer device wherein a vibrating plate is interposed in a predetermined flow path, at least one flow path hole opens on the vibrating plate, a gap is provided between the vibrating plate and a flow path wall opposed to the vibrating plate so that static pressure is generated between the vibrating plate and the flow path wall when the vibrating plate is vibrated in an ultrasonic range, and fluid is transferred by the static pressure.

8. The fluid transfer device according to claim 7, wherein the vibrating plate and the flow path wall are placed in parallel with the flow path, the gap between the vibrating plate and the flow path wall is set so as to be different from a gap between the vibrating plate and another flow path wall placed on a side opposite to the flow path wall across the vibrating plate.

9. The fluid transfer device according to claim 8, wherein a projecting piece projects toward the flow path hole of the vibrating plate from one of the two flow path walls placed on both sides of the vibrating plate.

10. The fluid transfer device according to claim 8, wherein a plurality of flow path holes open on the vibrating plate, and, of the plurality of flow path holes, a flow path hole located on a downstream side of the flow path has a greater inner diameter than that of a flow path hole located on an upstream side of the flow path.

11. The fluid transfer device according to claim 7, wherein the vibrating plate and the flow path wall are placed perpendicular to the flow path.

12. A fuel cell comprising the fluid transfer device according to any one of claims 1 to 11, wherein a membrane electrode assembly is placed along the flow path defined in the fluid transfer device.
